(19) United States
(12) Patent Application Publication
(10) Pub. No.: US 2026/0056864 A1
(43) Pub. Date: Feb. 26, 2026

(54) EXPLAINABILITY ANALYSIS IN REAL TIME FOR OPERATOR ASSURANCE, FEEDBACK, AND MACHINE LEARNING MODEL REFINEMENT

(71) Applicant: Lockheed Martin Corporation, Bethesda, MD (US)

(72) Inventors: Mustafa Zafar Abbasi, Austin, TX (US); Brandon Scott Liston, Marlton, NJ (US); Mauro Joseph Sanchirico, Moorestown, NJ (US)

(21) Appl. No.: 18/810,114

(22) Filed: Aug. 20, 2024

(51) Int. Cl. G06F 11/34; G06F 11/32

(52) U.S. Cl. CPC G06F 11/3447; G06F 11/328

(57) ABSTRACT

A computer-implemented method includes transforming sensor data into a first spatial representation, transforming a graphical user interface to display the first spatial representation, transforming the sensor data into a second spatial representation, providing the second spatial representation as input features to a machine learning model to generate inference data, providing the input features, parameters of the machine learning model, and the inference data to an explainability model to generate explainability data, transforming the explainability data into a third spatial representation, the third spatial representation being in a same space as the first spatial representation, and transforming the graphical user interface to overlay the third spatial representation on the first spatial representation.

### FIELD

The present disclosure relates to sensor-based remote sensing systems and, more particularly, to sensor-based remote sensing systems implemented using artificial intelligence techniques.

### SUMMARY

Enhancing sensor-based remote sensing systems (such as optical, radar, sonar, and seismic systems, among others) with artificial intelligence systems may provide various benefits for an end-user (e.g., a system or machine operator). For example, artificial intelligence systems (such as systems including machine learning models) may be able to analyze vast amounts of sensor data more quickly and accurately than human operators, which may reduce the chance of missing or misinterpreting signals. Machine learning models may excel at recognizing patterns in sensor data that might be too subtle or too complex for human operators to detect, which may improve the detection and classification of low-observable objects. Furthermore, machine learning models may process incoming sensor data in real-time or near-real time, speeding up the operator's decision-making process in critical time-sensitive situations where quick and accurate decision-making may be necessary.

However, machine learning models, particularly complex models (such as, for example, neural network-based models) used to process sensor data, are often regarded as “black boxes” because the models may make decisions in ways that may not be readily explainable to the operator. This lack of explainability or traceability can lead to a degradation of the operator's trust in the machine learning models, which can lead to various technical problems—particularly where machine learning models are deployed in critical applications. For example, if the operators do not trust a machine learning model, they may hesitate to deploy or employ the model, regardless of potential benefits of the model. This can delay or prevent the adoption of otherwise technically sound solutions. Furthermore, trust may be an essential component for healthy feedback loops (for example, users who trust the model may be more likely to provide meaningful feedback), which can be used to improve the model's performance over time.

Systems, apparatuses, methods, and techniques described in this specification provide solutions to these and other technical challenges by displaying visualizations of sensor data input into a machine learning model along with visualizations of explainability data that indicate which features of the input sensor data the model relies upon for inference. By showing where in the sensor data the model is focusing attention when making decisions, these visualizations can help operators quickly and intuitively understand the model's decision-making process.

Furthermore, displaying this information in a familiar format (e.g., in the same space as the visualization of the sensor data) allows operators to quickly determine whether the model is relying on the same portions of the input sensor data that the operator would, allowing the operator to confirm the model's decision quickly. Conversely, if the model focuses on unexpected portions of the input sensor data, the operator might identify potential inference errors, even if the model's final decision appears correct. This enhanced understanding can significantly increase the operator's trust in the machine-learning model.

Furthermore, presenting the explainability data in the same space where the operator typically views sensor data may be especially intuitive. For example, presenting the explainability data in a common space as sensor data may leverage the operator's existing familiarity with the data visualization format, allowing operators to seamlessly integrate their existing understanding of how sensor data may be visualized with the model's decision-making process and quickly and intuitively assess the reliability of the inference results, which may be especially beneficial during critical, time-sensitive operations. For example, when the explainability data shows that the model is focusing on the correct parts of the sensor data (“correct” meaning where an operator would similarly focus or flag), operators may be able to rely on the model's decisions confidently. Conversely, operators can promptly identify discrepancies if the model focuses on irrelevant or unexpected parts of the input sensor data. Thus, this intuitive visualization not only aids in real-time decision-making but also simplifies the process of generating feedback for model retraining, ensuring that the model improves over time.

According to example examples, a computer-implemented method includes transforming sensor data into a first spatial representation, transforming a graphical user interface to display the first spatial representation, transforming the sensor data into a second spatial representation, providing the second spatial representation as input features to a machine learning model to generate inference data, providing the input features, parameters of the machine learning model, and the inference data to an explainability model to generate explainability data, transforming the explainability data into a third spatial representation, the third spatial representation being in a same space as the first spatial representation, and transforming the graphical user interface to overlay the third spatial representation on the first spatial representation.

In other features, the first spatial representation and the third spatial representation are in a display space for output to a display and the second spatial representation is in a feature space for input to the machine learning model. In other features, the explainability data indicates a first area of the second spatial representation that the machine learning model is focusing on. In other features, the third spatial representation indicates a second area of the first spatial representation that maps to the first area.

In other features, the method includes transforming the graphical user interface to allow a user to indicate whether the machine learning model is focusing on a correct area of the first spatial representation, transforming the graphical user interface to allow the user to add a label indicating the correct area of the first spatial representation in response to the user indicating that the machine learning model is not focusing on the correct area of the first spatial representation, and retraining the machine learning model according to the label.

In other features, the method includes generating metrics based on the explainability data, determining whether the metrics meet a condition, and adding the explainability data to a machine learning training data store in response a determination of the metrics meeting the condition. The explainability data includes an attribution map indicating portions of the input features that the machine learning model is focusing attention on. In other features, the metrics include a variance in locations of centroids of the attribution map and the condition is met when the variance exceeds a threshold value.

In other features, the metrics include a change in a density of the attribution map and the condition is met when the change exceeds a threshold value. In other features, the metrics include a change in a number of centroids in the attribution map and the condition is met when the change exceeds a threshold value. In other features, the method includes transforming the inference data into a fourth spatial representation and transforming the graphical user interface to overlay the fourth spatial representation on the first spatial representation. The metrics include a number of intersections between portions of the attribution map and the fourth spatial representation and the condition is met when the number of intersections is below a threshold value.

Other examples provide a system including non-transitory computer-readable storage media storing instructions and at least one electronic processor. The at least one processor is configured to execute the instructions to transform sensor data into a first spatial representation, transform a graphical user interface to display the first spatial representation, transform the sensor data into a second spatial representation, provide the second spatial representation as input features to a machine learning model to generate inference data, provide the input features, parameters of the machine learning model, and the inference data to an explainability model to generate explainability data, transform the explainability data into a third spatial representation, the third spatial representation being in a same space as the first spatial representation, and transform the graphical user interface to overlay the third spatial representation on the first spatial representation.

In other features, the first spatial representation and the third spatial representation are in a display space for output to a display and the second spatial representation is in a feature space for input to the machine learning model. In other features, the explainability data indicates a first area of the second spatial representation that the machine learning model is focusing on. In other features, the third spatial representation indicates a second area of the first spatial representation that maps to the first area.

In other features, the electronic processor is further configured to execute the instructions to transform the graphical user interface to allow a user to indicate whether the machine learning model is focusing on a correct area of the first spatial representation, transform the graphical user interface to allow the user to add a label indicating the correct area of the first spatial representation in response to the user indicating that the machine learning model is not focusing on the correct area of the first spatial representation, and retrain the machine learning model according to the label.

In other features, the at least one electronic processor is further configured to execute the instructions to generate metrics based on the explainability data, determine whether the metrics meet a condition, and add the explainability data to a machine learning training data store in response a determination of the metrics meeting the condition. The explainability data includes an attribution map indicating portions of the input features that the machine learning model is focusing attention on. In other features, the metrics include a variance in locations of centroids of the attribution map and the condition is met when the variance exceeds a threshold value.

In other features, the metrics include a change in a density of the attribution map and the condition is met when the change exceeds a threshold value. In other features, the metrics include a change in a number of centroids in the attribution map and the condition is met when the change exceeds a threshold value. In other features, the at least one electronic processor is further configured to execute the instructions to transform the inference data into a fourth spatial representation and transform the graphical user interface to overlay the fourth spatial representation on the first spatial representation. The metrics include a number of intersections between portions of the attribution map and the fourth spatial representation and the condition is

Other examples, embodiments, features, and aspects will become apparent by consideration of the detailed description and accompanying drawings.

### BRIEF DESCRIPTION OF THE DRAWINGS

FIG. 1 is a block diagram illustrating an example computing system for remote sensing applications, according to some embodiments.

FIG. 2 is a block diagram illustrating an example sensor processing platform, according to some embodiments.

FIGS. 3 and 4 show an example process of generating visualizations of sensor data and explainability data, according to some embodiments.

FIG. 5 shows an example of a graphical user interface displaying processed sensor data, according to some embodiments.

FIG. 6 illustrates a graphical user interface in which inference display data is overlaid on processed sensor data, according to some embodiments.

FIG. 7 illustrates an example of a graphical user interface in which inverted explainability data is overlaid on processed sensor data, according to some embodiments.

FIG. 8 illustrates an example of a graphical user interface including elements allowing the operator to provide feedback, according to some embodiments.

FIG. 9 is a flowchart of an example process for generating training data for and retraining a machine learning model, according to some embodiments.

FIG. 10 is a flowchart of an example process for monitoring performance of a machine learning model, according to some embodiments.

In the drawings, reference numbers may be reused to identify similar and/or identical elements.

### DETAILED DESCRIPTION

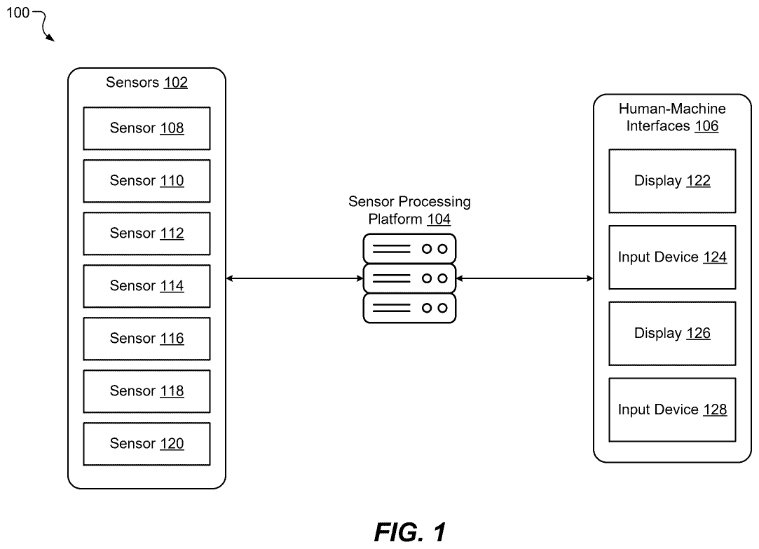

FIG. 1 is a block diagram illustrating an example computing system 100 for remote sensing applications. In the example of FIG. 1, the system 100 includes one or more sensor 102, a sensor processing platform 104, and one or more human-machine interfaces 106. As will be described, the sensor processing platform 104 may receive sensor data from one or more sensors 102, process the sensor data, and output the processed sensor data via one or more of the human-machine interfaces 106. In various implementations, an operator interacts with the sensor processing platform 104 and/or the sensors 102 via the human-machine interfaces 106. Examples of sensors 102 include (but are not limited to) electro-optical (EO) sensors 108, infrared (IR) sensors 110, radar sensors 112, sonar sensors 114, lidar sensors 116, ultrasonic sensors 118, seismic sensors 120, etc. While seven sensors 102 are illustrated in the example of FIG. 1, the system 100 may include any number and combination of sensors as may be appropriate for particular applications.

Examples of human-machine interfaces 106 include devices that allow humans to interact with the sensor processing platform, such as input and/or output devices. Examples of input devices include keyboards, mice, touchpads, joysticks, touchscreens, microphones, scanners, handheld controllers, etc. Examples of output devices include displays, projectors, virtual reality devices, speakers, headphones, etc. In the example of FIG. 1, the human-machine interfaces 106 include a display 122, an input device 124, a display 126, and an input device 128. However, in other examples, the human-machine interfaces 106 may include any combination of input and/or output devices as may be appropriate for particular applications.

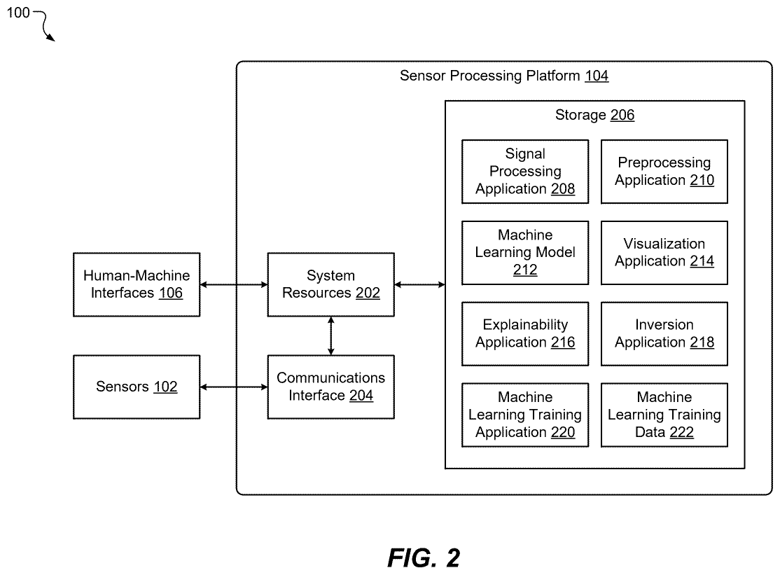

FIG. 2 is a block diagram illustrating an example sensor processing platform 104. The sensor processing platform 104 may include system resources 202, a communications interface 204, and/or non-transitory computer-readable storage media, such as, for example, storage 206. The non-transitory computer-readable storage media may contain instructions that, when executed, cause one or more electronic processors (such as one or more electronic processors of the sensor processing platform 104) to perform various functions described herein. In various implementations, the system resources 202 include one or more electronic processors, one or more graphics processing units, volatile computer memory, non-volatile computer memory, and/or one or more system buses interconnecting the components of the sensor processing platform 104. In some examples, the communications interface 204 includes hardware and software components that communicate with other elements of the system 100. For example, the system resources 202 may communicate with the sensors 102 via the communications interface 204.

In various implementations, the communications interface 204 supports/may be implemented according to one or more serial communication standards, including RS-232, RS-485, Universal Asynchronous Receiver/Transmitter (UART), Inter-Integrated Circuit (I2C), Serial Peripheral Interface (SPI), and/or Universal Serial Bus (USB). In some examples, the communications interface 204 supports communicating over a Controller Area Network (CAN).

In various implementations, the communications interface 204 may connect to various networks. These can include mobile networks such as General Packet Radio Service (GPRS), Time-Division Multiple Access (TDMA), Code-Division Multiple Access (CDMA), Global System for Mobile Communications (GSM), Enhanced Data Rates for GSM Evolution (EDGE), High-Speed Packet Access (HSPA), Evolved High-Speed Packet Access (HSPA+), Long Term Evolution (LTE), Worldwide Interoperability for Microwave Access (WiMAX), and/or 5th-generation mobile networks (5G). The communications interface 204 may also connect to network types such as Internet Protocol (IP) networks, Wireless Application Protocol (WAP) networks, and/or IEEE 802.11 standards networks.

In some examples, the communications interface 204 may connect to optical networks, local area networks (LANs), global communication networks like the Internet, and personal area networks (PANs) such as Bluetooth and Zigbee networks. In various implementations, the communications interface 204 communicates with the sensors 102 via any of the previously described standards, networks, etc.

The storage 206 may include one or more software applications, which one or more electronic processors and/or one or more graphics processing units of the shared system resources 202 executes. The shared system resources 202 may communicate with the human-machine interfaces 106, and operators can use the human-machine interfaces 106 to interact with the running software applications. In various implementations, the storage 206 includes a signal processing application 208, a preprocessing application 210, a machine learning model 212, a visualization application 214, an explainability application 216, an inversion application 218, and/or a machine learning training application 220. In some examples, the storage 206 includes machine learning training data 222. The functionality of the software applications will be described with references to the FIG.

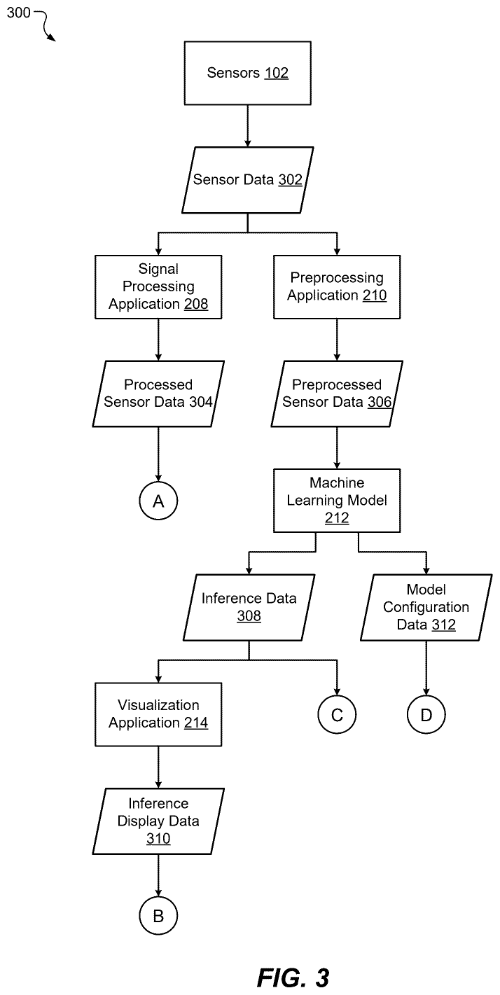

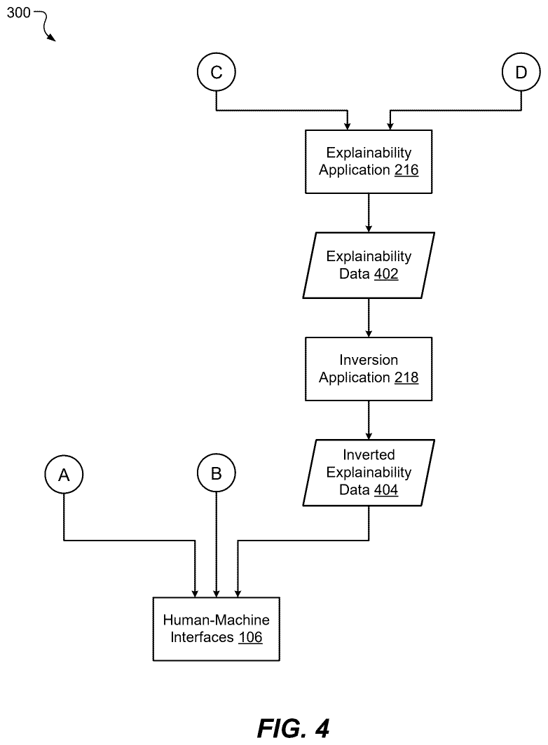

FIGS. 3 and 4 show an example process 300 of generating visualizations of sensor data and explainability data. As illustrated in the example process 300, the signal processing application 208 may receive sensor data 302 generated by the sensors 102. The signal processing application 208 may process the sensor data 302 and transform the sensor data 302 into processed sensor data 304. The processed sensor data 304 may be transformed into a spatial format suitable for output to the operator via one or more of the human-machine interfaces 106. For example, the signal processing application 208 may acquire raw sensor data 302 from one or more of the sensors 102. The signal processing application 208 may apply pre-processing operations to the sensor data 302 to clean and/or filter the sensor data 302 (for example, by removing noise and/or irrelevant information from the sensor data 302).

The signal processing application 208 may identify and/or extract important features from the preprocessed sensor data (for example, edges in optical image data, thermal gradients in infrared image data, object reflections in radar data, etc.). In examples where the sensors 102 include multiple sensors of the same type or different types, the signal processing application 208 may perform data fusion operations to combine data from multiple sensors to provide a more comprehensive view. For example, the signal processing application 208 may combine data from multiple visual sensors to provide a wider field of view or combine visual and infrared data to provide for an enhanced image. The signal processing application 208 may transform the sensor data 302 into a spatial format suitable for display.

In various implementations, the signal processing application 208 receives visual light data from the electro-optical sensor 108 as sensor data 302, applies image enhancement, noise reduction, and/or filtering to the sensor data 302, and generates images or videos suitable for display as processed sensor data 304. In some examples, the signal processing application 208 receives infrared radiation data from the infrared sensor 110 as sensor data 302, applies thermal image processing (such as, for example, applying false color imaging techniques to highlight temperature differences) to the sensor data 302, and generates thermal images showing temperature variations as processed sensor data 304.

In various implementations, the signal processing application 208 receives radio wave reflection data from the radar sensor 112 as sensor data 302, applies signal processing to the sensor data 302 to extract range, velocity, and/or position information, and generates radar plots and/or maps that visualize detected objects'positions and/or movements as processed sensor data 304. In some examples, the signal processing application 208 receives sound wave data from the sonar sensor 114 as sensor data 302, applies time-of-flight calculations and/or echo profiling techniques to the sensor data 302, and generates visual representations (such as spectrograms) and/or 3D models of underwater terrain and/or objects as processed sensor data 304.

In various implementations, the signal processing application 208 receives laser pulse data from the lidar sensor 116 as sensor data 302, applies time-of-flight calculations and/point cloud generation techniques to the sensor data 302, and generates 3D point clouds and/or terrain maps as processed sensor data 304. In some examples, the signal processing application 208 receives ultrasonic sound wave data from the ultrasonic sensor 118 as sensor data 302, applies distance measurement calculations and/or imaging techniques to the sensor data 302, and generates distance measurements and/or ultrasonic images as processed sensor data 304.

In various implementations, the signal processing application 208 receives vibration and/or seismic wave data from the seismic sensor 120 as sensor data 302, applies waveform analysis and/or event detection techniques to the sensor data 302, and generates seismographs and/or 3D models of subsurface structures as processed sensor data 304. The signal processing application 208 may output the processed sensor data 304 for display via the human-machine interfaces 106 (such as via the display 122 and/or the display 126). It should be understood that although examples described herein may relate to particular types of sensors and/or data, implementations described herein may be used with various types of sensors and data and the examples provided herein should not be considered limiting.

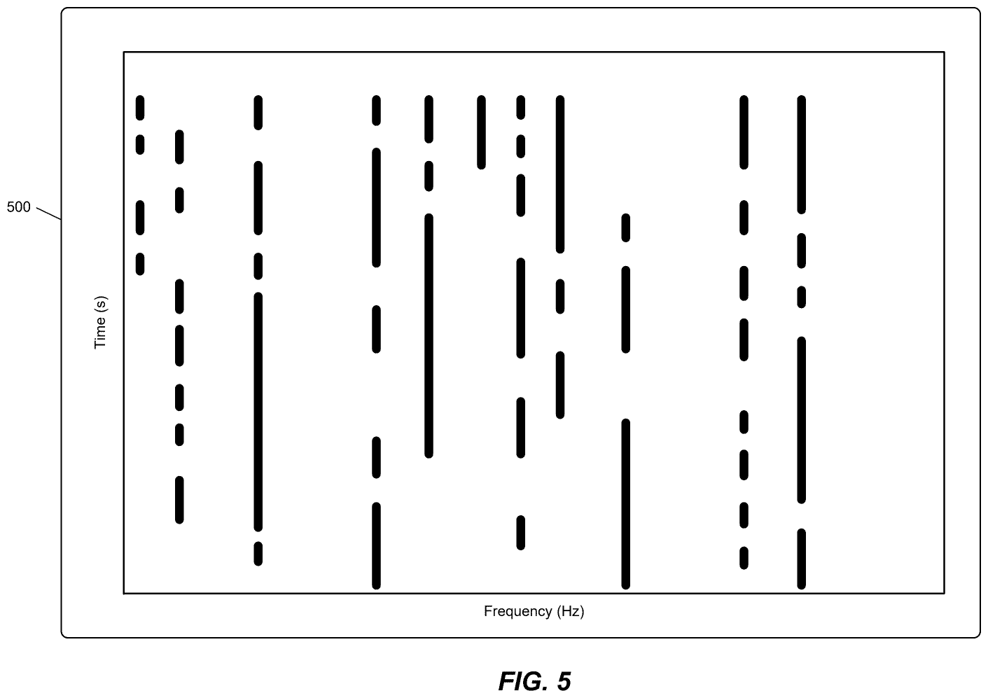

FIG. 5 shows an example of a graphical user interface 500 displaying processed sensor data 304. In various implementations, the signal processing application 208 may generate and output the graphical user interface 500 to a display of the human-machine interfaces 106, such as the display 122 and/or the display 126. In the example of FIG. 5, the processed sensor data 304 may be generated from sensor data 302 that includes sound wave data from the sonar sensor 114, and the processed sensor data 304 may be presented as a spectrogram on the graphical user interface 500. The spectrogram may plot frequency components (Hz) along the x-axis and advances these components at increments of time(s) along the y-axis. This time-frequency representation may allow the operator to quickly and intuitively analyze the dynamic behavior of the sonar sensor data 302, enabling the identification and/or classification of features such as echoes from underwater objects, marine life, and underwater phenomena that reflect sound waves.

Returning to FIGS. 3 and 4, the preprocessing application 210 receives the sensor data 302 and transforms the raw sensor data 302 into a feature space suitable for input to machine learning models (e.g., as refined input vectors, matrices, and/or tensors). The preprocessing application 210 may receive raw sensor data 302 from the sensors 102, apply processing steps to clean, enhance, and/or standardize the data, and generate preprocessed sensor data 306 in a structured format (e.g., as vectors, matrices, and/or tensors sized for input to machine learning models) that highlights relevant features and removes noise. In various implementations, the preprocessing application 210 receives visual light data from the electro-optical sensor 108 as sensor data 302, applies techniques such as noise reduction, image enhancement, segmentation, and/or normalization to the sensor data 302, and generates vectors, matrices, and/or tensors suitable for input to a machine learning model as preprocessed sensor data 306.

In various some examples, the preprocessing application 210 receives infrared radiation data from the infrared sensor 110 as sensor data 302, applies techniques such as noise reduction, contrast enhancement, edge detection, and/or normalization to the sensor data 302, and generates vectors, matrices, and/or tensors suitable for input to a machine learning model. In some examples, the preprocessing application 210 receives radio wave reflection data from the radar sensor 112 as sensor data 302, applies techniques such as clutter removal, Doppler filtering, range-Doppler mapping, and/or normalization to the sensor data 302, and generates vectors, matrices, and/or tensors suitable for input to a machine learning model as preprocessed sensor data 306.

In various implementations, the preprocessing application 210 receives sound wave reflection data from the sonar sensor 114 as sensor data 302, applies techniques such as noise reduction, echo detection, time-gating, and/or normalization to the sensor data 302, and generates vectors, matrices, and/or tensors suitable for input to a machine learning model. In some examples, the preprocessing application 210 receives laser pulse data from the lidar sensor 116 as sensor data 302, applies techniques such as noise filtering, point cloud registration, segmentation to the sensor data 302, and/or normalization to the input data, and generates vectors, matrices, and/or tensors suitable for input to a machine learning model as preprocessed sensor data 306.

In various implementations, the preprocessing application 210 receives ultrasonic sound wave data from the ultrasonic sensor 118 as sensor data 302, applies techniques such as noise reduction, echo detection, time-of-flight calculation, and/or normalization to the sensor data 302, and generates vectors, matrices, and/or tensors suitable for input to a machine learning model as preprocessed sensor data 306. In some examples, the preprocessing application 210 receives vibration and/or seismic wave data from the seismic sensor 120 as sensor data 302, applies techniques such as noise filtering, event detection, waveform analysis, and/or normalization to the sensor data 302, and generates vectors, matrices, and/or tensors suitable for input to a machine learning model as preprocessed sensor data 306.

The machine learning model 212 may receive the preprocessed sensor data 306 as inputs and generate inference data 308 based on the input preprocessed sensor data 306. In various implementations, the machine learning model 212 is trained to output inference data 308 that detects, classifies, and/or tracks targets present in the sensor data 302. In some examples, the machine learning model 212 is trained to output inference data 308 that otherwise measures the sensor data 302. In various implementations, the sensor data 302 includes data from electro-optical sensors 108, and the machine learning model 212 outputs inference data 308 that detects and locations objects, categorizes detects objects, and/or tracks the movement of objects in an image and/or a sequence of images. Examples of suitable machine learning models include convolutional neural networks (CNNs) for image recognition and/or recurrent neural networks (RNNs) for tracking moving objects over time.

In some examples, the sensor data 302 includes data from infrared sensors 110, and the machine learning model 212 outputs inference data 308 that identifies high areas of thermal activity, detects unusual thermal patterns indicative of potential objects of interest, and/or monitors the movements of heat-emitting objects. Examples of suitable machine learning models include deep learning models, such as models implemented according to the You Only Look Once (YOLO) algorithm and/or single-shot detector (SSD) models for detecting heat signatures, and/or generative adversarial networks (GANs) for enhancing image resolution. In various implementations, the sensor data 302 includes data from radar sensors 112, and the machine learning model 212 outputs inference data 308 that identifies measures the distance and/or speed of targets, identifies the types of targets, and/or predicts future positions of moving targets.

Examples of suitable machine learning models include recurrent neural networks such as long short-term memory (LSTM) networks and/or gated recurrent unit (GRU) networks for time-series analysis and/or predicting target trajectories, transformer networks for processing for processing sequential radar data, convolution-based networks such CNNs, and/or support vector machines (SVMs) for classifying detected objects based on radar signatures.

In some examples, the sensor data 302 includes data from sonar sensors 114, and the machine learning model 212 outputs inference data 308 that identifies and/or classifies underwater objects (e.g., based on their acoustic signatures). Examples of suitable machine learning models may include autoencoders for noise reduction and feature extraction, and/or neural networks such as K-nearest neighbors (KNN) models for classifying underwater objects based on their acoustic signatures. In various implementations, the sensor data 302 includes data from lidar sensors 116, and the machine learning model 212 outputs inference data 308 that identifies and/or locates objects in a 3D space and/or classifies objects based on their 3D shapes. Examples of suitable machine learning models include neural networks for processing 3D point cloud data, and/or random forests for segmenting and/or classifying objects in 3D space.

In some examples, the sensor data 302 includes data from ultrasonic sensors 118, and the machine learning model 212 outputs inference data 308 that detects and/or classifies objects based on their reflected ultrasonic waves. Examples of suitable machine learning models may include decision trees for classification tasks and/or neural networks for complex pattern recognition and classification tasks. In various implementations, the sensor data 302 includes data from seismic sensors, and the machine learning model 212 outputs inference data 308 that identifies and/or classifies seismic events. Examples of suitable machine learning models may include time series models for analyzing and/or predicting seismic activity, and/or neural networks for detecting and/or classifying seismic events.

The inference data 308 may be provided to a visualization application 214, which transforms the inference data 308 into inference display data 310. For example, the visualization application 214 transforms the inference data 308 from an inference space (e.g., where the data is originally processed and/or structured) to a display space (e.g., where the data may be visually represented for human interpretation). In various implementations, the inference display data 310 is in the same display space as the processed sensor data 304. Thus, the inference display data 310 may be output to the operator via one or more of the displays of the human-machine interfaces 106. In various implementations, the inference display data 310 is displayed alongside the processed sensor data 304. For example, the processed sensor data 304 may be output to the display 122 and the inference display data 310 may be output to the display 126. In some examples, the inference display data 310 is overlaid on top of the processed sensor data 304. For example, the processed sensor data 304 may be output to the display 122, and the inference display data 310 may be overlaid on top of the processed sensor data 304 on the display 122.

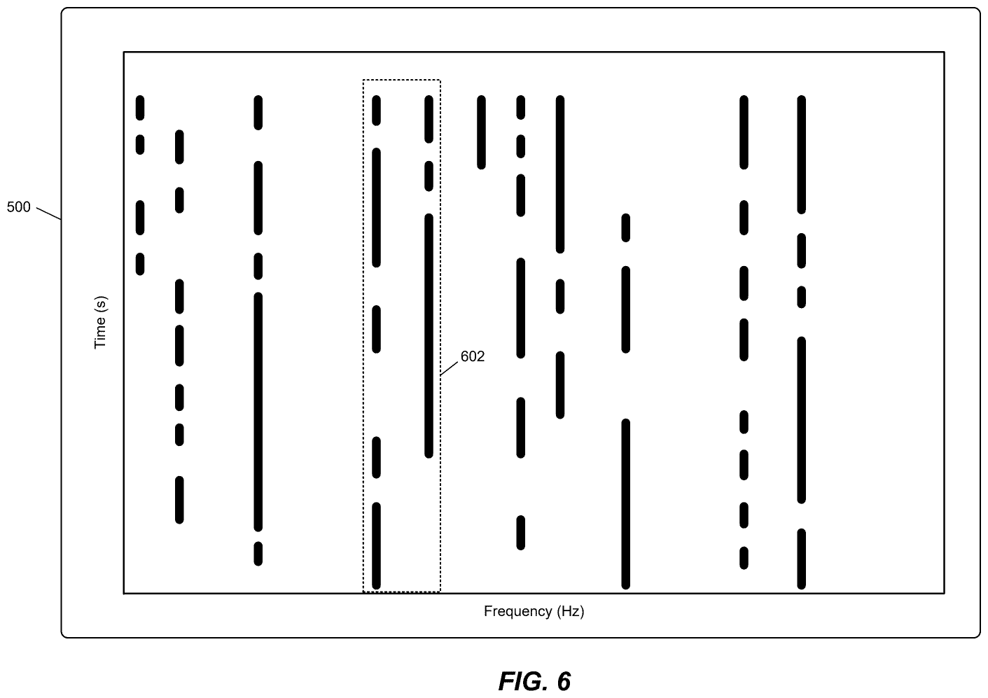

FIG. 6 illustrates an example of the graphical user interface 500, where inference display data 310 is overlaid on processed sensor data 304. In the example of FIG. 6, the processed sensor data 304 is the processed sensor data 304 from the example of FIG. 5, and the inference display data 310 represents a target that the machine learning model 212 detected, classified, and/or tracked. The inference display data 310 may be overlaid as an annotation 602, which represents the target in the same display space as the processed sensor data 304.

Returning to FIGS. 3 and 4, the machine learning model 212 may also output model configuration data 312. The model configuration data 312 may include architectural details, training parameters, feature information, weights and/or biases, explainability-specific data, hyperparameters, and/or other configuration data of the machine learning model 212. Architectural details may include the model type (e.g., whether the model is a neural network, decision tree, ensemble method, etc.), layer configuration (e.g., details about the number and types of layers, etc.), decision paths, etc. Training parameters may include the learning rate, batch size, number of epochs, optimizer function, loss function, etc. Feature information may include the names and/or data types of the features used in the machine learning model 212, feature importance scores, preprocessing details about how the input data is processed, etc.

Explainability-specific data may include attention weights (e.g., for models that use attention mechanisms), activation maps (e.g., visualizing the features detected at each layer of a convolutional neural network), etc.

The inference data 308 and/or the model configuration data 312 may be provided as inputs to an explainability application 216. The explainability application 216 may output explainability data 402 that identifies features (e.g., inputs) that have the most influence on the outputs from the machine learning model 212. In various implementations, the explainability data 402 identifies the features of the sensor data 302 and/or the preprocessed sensor data 306 that the machine learning model 212 focuses attention on when it generates the inference data 308. In some examples, the explainability application 216 generates the explainability data 402 according to the integrated gradients method. The integrated gradients method provides feature importance scores by computing the gradients of the model's outputs with respect to each input feature and integrating the gradients over a path from a baseline input to the actual input. In examples where the explainability application 216 implements the integrated gradients method, the explainability data 402 may include feature attributions indicating how much each input feature (e.g., from the sensor data 302 and/or the preprocessed sensor data 306) contributed to the model's prediction.

In various implementations, the explainability application 216 generates the explainability data 402 according to the occlusion method. The occlusion method evaluates the importance of each input feature by systematically occluding (masking) parts of the input and observing the corresponding change in the model's output. In examples where the explainability application 216 implements the occlusion method, the explainability data 402 may include the impact sores of different input features, which shows how the model's predictions change when specific features are masked. In some examples, the explainability application 216 generates the explainability data 402 according to the Shapley additive explanations (SHAP) method. The SHAP method computes the contribution of each feature to the model's output based on cooperative game theory (e.g., using Shapley values). In examples where the explainability application 216 implements the SHAP method, the explainability data 402 may include Shapley values for each input feature, which may represent an average contribution of each feature to the model's prediction across possible subsets of features.

In various implementations, the explainability application 216 generates the explainability data 402 according to the local interpretable model-agnostic explanations (LIME) method. The LIME method explains individual predictions by approximating the model locally using an interpretable model (for example, a linear regression model). In examples where the explainability application 216 implements the LIME method, the explainability data 402 may include local feature importance scores showing which features are most influential for specific predictions. In some examples, the explainability application 216 generates the explainability data 402 according to the feature permutation importance method. The feature permutation importance method measures the importance of features by evaluating changes in the model's performance when input feature values are randomly permuted. In examples where the explainability application 216 implements the feature permutation importance method, the explainability data 402 may include importance scores for each feature, indicating how the model's accuracy is affected by permuting each feature.

The explainability application 216 may provide the explainability data 402 to the inversion application 218, and the inversion application 218 may transform the explainability data 402 from the feature space to the display space (e.g., the spatial domain of the processed sensor data 304) as inverted explainability data 404. Since the inverted explainability data 404 may be transformed to the same spatial domain as the processed sensor data 304, the inverted explainability data 404 may be output to one or more displays of the human-machine interfaces 106 alongside and/or overlaid on the processed sensor data 304. For example, the processed sensor data 304 may be output to the display 122 and the inverted explainability data 404 may be output to the display 126. In various implementations, the processed sensor data 304 is output to the display 122 and the inverted explainability data 404 is overlaid on the processed sensor data 304 on the display 122.

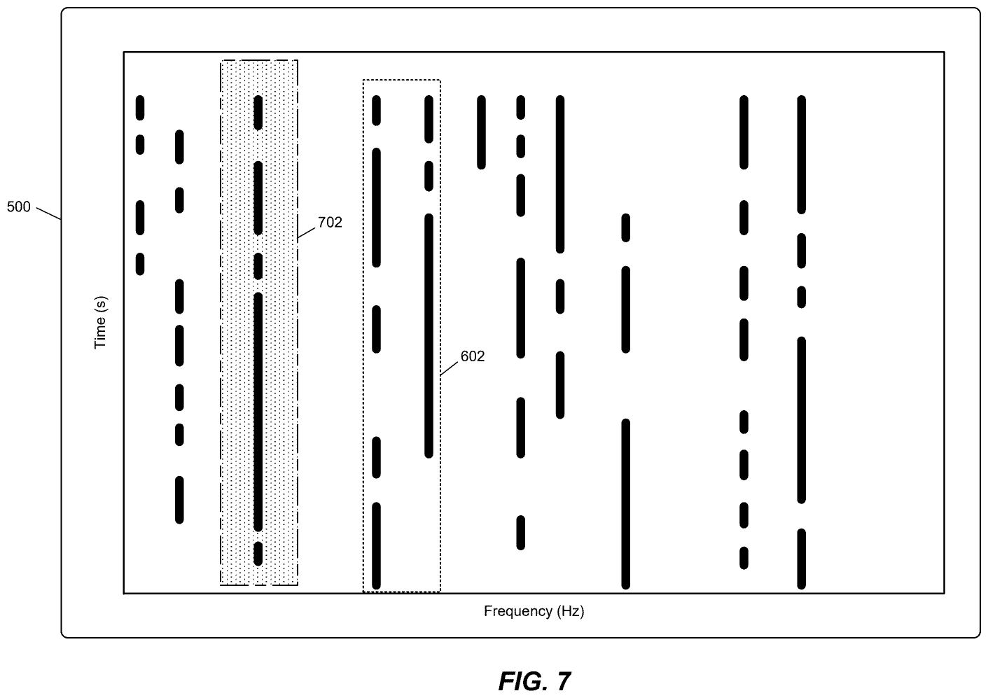

FIG. 7 illustrates an example of the graphical user interface 500, where inverted explainability data 404 is overlaid on processed sensor data 304. In the example of FIG. 7, the processed sensor data 304 is the processed sensor data 304 from the examples of FIGS. 5 and 6, and the inverted explainability data 404 represents the features of the sensor data 302 provided as inputs to the machine learning model 212 (for example, as processed sensor data 304) that have the most influence on the outputs from the machine learning model 212. Since the inverted explainability data 404 is in the same display space as the processed sensor data 304 and/or the inference display data 310, the inverted explainability data 404 may be output to the graphical user interface 500 as an overlay 702 on top of the processed sensor data 304 and/or alongside the annotation 602. Thus, the overlay 702 may highlight the portions of the processed sensor data 304 that the machine learning model 212 is focusing its attention on when performing inference. In various implementations, the overlay 702 is a heatmap. In some examples, the overlay 702 is an attribution map.

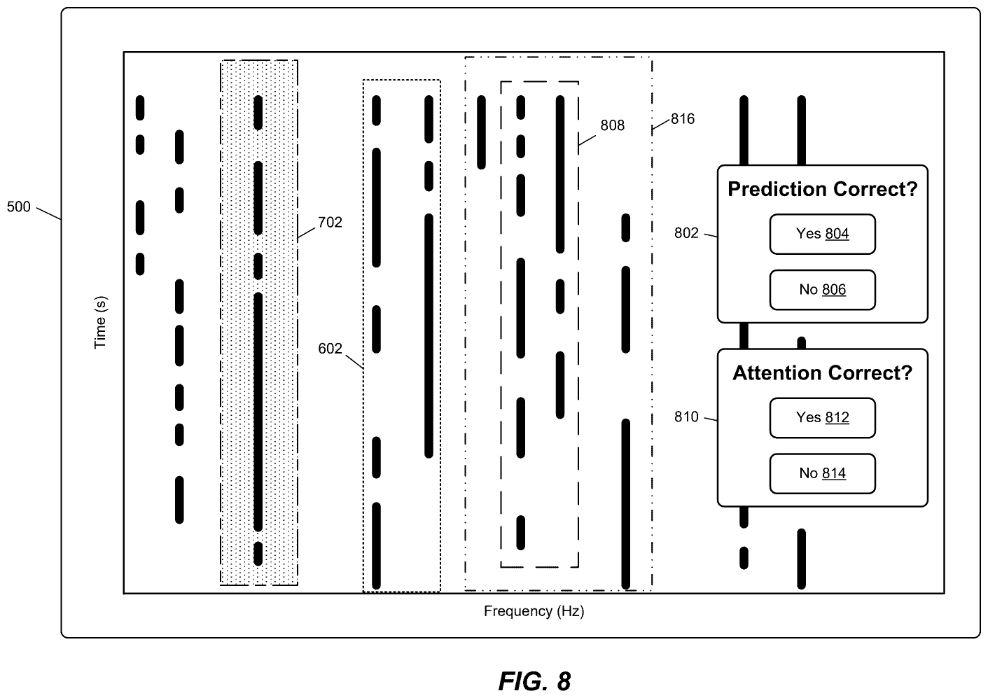

FIG. 8 illustrates an example of the graphical user interface 500 including elements allowing the operator to provide feedback. The machine learning training application 220 may generate a graphical user interface element such as an interactive prompt 802 asking the operator whether the predictions by the machine learning model 212 (such as the target/classification indicated by annotation 602) are correct. The interactive prompt 802 may have a selectable button 804, allowing the operator to indicate that the predictions are correct, and a selectable button 806, allowing the operator to indicate that the predictions are not correct. In response to the user selecting the selectable button 806 (indicating that the predictions are not correct), the machine learning training application 220 configures the graphical user interface 500 to allow the operator to annotate (via an annotation 808) the correct prediction on the graphical user interface 500.

The machine learning training application 220 may also generate a graphical user interface element such as an interactive prompt 810 asking the operator whether the machine learning model 212 is focusing its attention on the correct input features (for example, as indicated by the overlay 702). For example, the operator may determine that the machine learning model 212 is focusing its attention on the correct input features when the overlay 702 aligns with the portions of the processed sensor data 304 displayed on the graphical user interface 500 that the operator would be analyzing to make a decision. The interactive prompt 810 may have a selectable button 812, allowing the operator to indicate that the machine learning model 212 is focusing its attention on the correct input features, and a selectable button 814, allowing the operator to indicate that the machine learning model 212 is not focusing its attention on the correct input features. In response to the user selecting the selectable button 814 (indicating that the machine learning model 212 is not focusing its attention on the correct input features), the machine learning training application 220 configures the graphical user interface 500 to allow the operator to annotate (via an annotation 816) the correct input features that the machine learning model 212 should be focusing attention on via the graphical user interface 500.

The machine learning training application 220 may save the processed preprocessed sensor data 306, the inference data 308, the model configuration data 312, the explainability data 402, and/or the inverted explainability data 404 to the machine learning training data 222 as labeled and/or annotated data. In various implementations, the machine learning model 212 is retrained at the sensor processing platform 104 (also referred to as on the edge) using the machine learning training data 222. In some examples, the machine learning training data 222 is saved for future retraining.

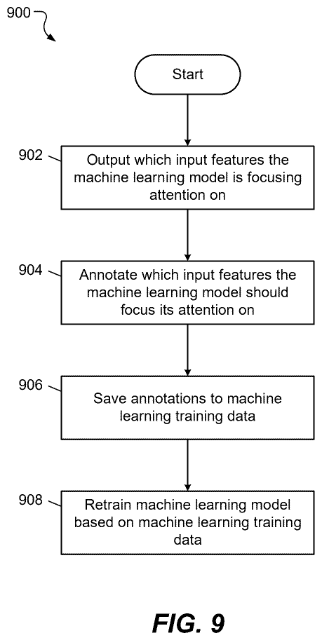

FIG. 9 is a flowchart of an example process 900 for generating training data for and retraining the machine learning model 212. In the example process 900, the signal processing application 208 outputs the processed sensor data 304 via the graphical user interface 500, and the inversion application 218 outputs the inverted explainability data 404 to the graphical user interface 500 as the overlay 702 (at block 902). In the example process 900, the operator interacts with the graphical user interface 500 and adds an annotation 816 indicating which input features the machine learning model 212 should be focusing its attention on (at block 904). In the example process 900, the machine learning training application 220 saves the annotations to machine learning training data 222 (at block 906). In the example process 900, the machine learning training application 220 retrains the machine learning model 212 using the machine learning training data 222 (at block 908).

In various implementations, the machine learning training application 220 performs end-to-end fine-tuning of an existing machine learning model 212. End-to-end fine-tuning may include retraining the entire machine learning model 212 using the new training data 222, which may include annotations 816 indicating which input features the machine learning model 212 should be focusing attention on. Thus, the machine learning training application 220 may adjust any number of layers (including one or all) of the machine learning model 212 based on the new training data 222. The annotations in the training data 222 may guide the machine learning model 212 to focus on the correct parts of the input features, ensuring that the model's attention mechanism is aligning with the areas highlighted by the annotations.

In some examples, the machine learning training application 220 fine-tunes one or more layers of an existing machine learning model 212. Fine-tuning one or more layers may involve selectively retraining certain layers of the machine learning model 212 while keeping other layers frozen (e.g., fixed). For example, the machine learning training model 220 may fine-tune later layers of the machine learning model 212, as these layers may be more task-specific. The training data 222 may be used to adjust these layers so that the model's attention aligns with the annotations. This approach may be less computationally intensive than a comprehensive end-to-end fine-tuning approach, allowing the system 100 to quickly adapt the machine learning model 212 based on user feedback (e.g., annotations 816).

In various implementations, the machine learning training application 220 fine-tunes a task layer on outputs of a foundational model (which may, depending on application, be a pre-trained foundational model or an existing model such as the machine learning model 212). For example, the machine learning training application 220 may add a task-specific layer on top of the machine learning model 212. The machine learning training application 220 may tune the task-specific layer (for example, without tuning the remainder of the foundational model) using the training data 222. Thus, the foundational model may remain unchanged and provide a stable base of generalized features. The machine learning training application 220 may use the annotations in the training data 222 to guide the new task layer to learn to focus on relevant parts of the input features.

In some examples, the machine learning model 212 includes an interface ensemble, and the machine learning training application 220 adds a new member to the interface ensemble and trains the new member end-to-end. An interface ensemble may consist of multiple models working together. The machine learning training application 220 adds a new member and trains the new model from scratch (e.g., from initialized/initial random weights) using the training data 222. The new member may be trained end-to-end, learning to interpret the input features and focus attention correctly on the important areas as indicated by the annotations 816.

In various implementations, the machine learning model 212 includes an interface ensemble, the machine learning training application 220 adds a new member to the interface ensemble and, instead of training the new member from scratch, trains the new member using one of the existing members of the interface ensemble as a starting point. For example, the machine learning training application 220 may initialize the new member using weights from an existing member. The new member may then be fine-tuned using the training data 222. This helps the machine learning model 212 to quickly focus its attention to the task (e.g., using the training data 222) while leveraging existing knowledge (e.g., using the existing member as a starting point).

In some examples, the machine learning model 212 includes a reservoir network and the machine learning training application 220 fine-tunes outputs of the reservoir network. Reservoir networks may maintain dynamic pools of interconnected nodes. Fine-tuning the outputs of a reservoir network may include adjusting the weights associated with the output layer using the annotated training data 222 (for example, while leaving the reservoir itself unchanged). Leaving the reservoir unchanged may preserve the dynamic properties of the reservoir network, and fine-tuning the output layer ensures that the outputs of the machine learning model 212 align with the annotations (e.g., aligning the reservoir network's attention).

In various implementations, the machine learning training application 220 fine-tunes the machine learning model 212 (e.g., according to any of the previously described techniques) by penalizing the machine learning model 212 when it focuses on incorrect parts of the input features (e.g., based on a comparison between the model's attention and the annotations). The machine learning training application 220 may penalize the machine learning model 212 by adding a penalty term to the loss function used during retraining, which may discourage the model from focusing attention on incorrect regions of the input features, aligning its attention with the annotated areas.

In some examples, the machine learning training application 220 fine-tunes the machine learning model 212 (e.g., according to any of the previously described techniques) by penalizing the machine learning model 212 when there is a high variance in attribution maps (such as any of the previously described attribution maps). As previously described, high variance may indicate instability and/or inconsistency in the model's attention. Adding a penalty term to the loss function that penalizes high variance may ensure that the machine learning model 212 learns to focus and/or stabilize its attention, which may improve reliability.

In various implementations, the machine learning training application 220 fine-tunes the machine learning model 212 by incentivizing attention through mutual information. For example, the machine learning training application 220 may use annotations from the training data 222 to compute the mutual information between the raw input features and the annotations, and the mutual information between the portions of the input features the model focuses attention on and the annotations. The machine learning training application 220 may fine-tune the machine learning model 212 to maximize this mutual information, which may incentivize the model to focus on portions of the input features that are most informative for the task.

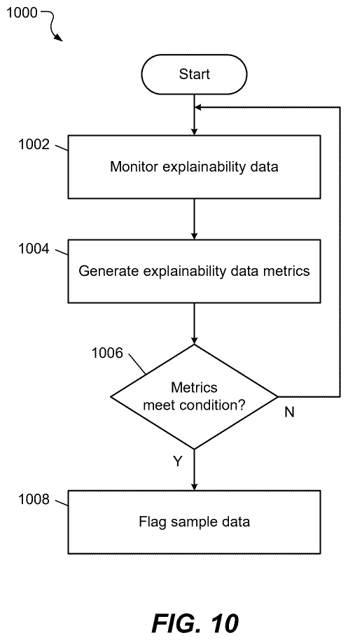

FIG. 10 is a flowchart of an example process 1000 for monitoring performance of the machine learning model 212. In the example process 1000, the machine learning training application 220 may monitor the explainability data 402 and/or the inverted explainability data 404 (at block 1002). In the example process 1000, the machine learning training application 220 generates metrics based on the explainability data 402 and/or the inverted explainability data 404 (at block 1004). In various implementations, the explainability data 402 and/or the inverted explainability data 404 include attribution maps, and examples of metrics include “variance in the location of centroids of the attribution maps,” “densities of attribution maps,” “numbers of centroids in the attribution maps,” and/or intersections of the attribution maps with object detections.”

The “variance in the location of centroids of the attribution maps” metric measures how much the focal points (indicated by the centroids) vary across different instances (e.g., different attribution maps). High variance may indicate that the machine learning model 212 inconsistently focuses on different areas for similar types of inputs. The “densities of the attribution maps” metric may measure how concentrated the attention of the machine learning model 212 is in certain areas of the input features. Low density may imply diffused attention across input features, while high density might suggest concentrated attention on specific features.

The “numbers of centroids in the attribution maps” metric measures the number of distinct focal areas that the machine learning model 212 considers important. Multiple centroids may suggest that the machine learning model 212 is focusing on many input features, while few centroids may suggest that the machine learning model 212 is focusing on a limited number of input features. The “intersections of the attribution maps with object detections” metric may indicate where the areas deemed important by the model overlap with the actual locations of the detected objects.

In the example process 1000, the machine learning training application 220 determines whether the computed metrics meets a certain condition (at decision block 1006). In various implementations, the condition includes peaks and/or valleys of the metrics (computed over time). Peaks may be an indicator of when the machine learning model 212 is exhibiting an unusually high confidence or focus (potentially indicating overfitting), while valleys may be an indicator of when the machine learning model 212 lacks confidence or fails to recognize or assign appropriate weights to important input features (potentially indicating underfitting). In some examples, the condition includes high variances in the “variance in the location of centroids of the attribution maps” metric. Such variances may indicate unreliable object tracks.

In various implementations, the condition includes increases or decreases in the “densities of the attribution maps” metric. Increases or decreases in the densities may indicate a shifting focus of the machine learning model 212 between individual objects in a scene and a broader background. In some examples, the condition includes increases or decreases in the “numbers of centroids in the attribution maps” metric. Such increases or decreases can indicate the appearance of additional objects or the loss of certain objects from a scene. In various implementations, the condition includes the “intersections of the attribution maps with object detections” metric falling below a threshold. A higher number of intersections may indicate that the machine learning model 212 is correctly focusing on relevant input features. In contrast, a low number of intersections may indicate that the machine learning model 212 is focusing on unreliable background clutter.

In response to the metrics not meeting the condition (“NO” at decision block 1006), the machine learning training application 220 continues monitoring the explainability data at block 1002. In response to the metrics meeting the condition (“YES” at decision block 1006), the machine learning training application 220 flags the sample data (at block 1008). In various implementations, the sample data includes the metrics meeting the condition and/or any sensor data 302, processed sensor data 304, preprocessed sensor data 306, inference data 308, inference display data 310, model configuration data 312, explainability data 402, and/or inverted explainability data 404 associated with the metrics meeting the condition. The flagged sample data may be saved to the machine learning training data 222 for refinement and/or retraining of the machine learning model 212.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order —or processes may be executed concurrently or in combination with each other —without altering the principles of this disclosure. Similarly, instructions stored in a non-transitory computer-readable medium may be executed in a different order —or concurrently —without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one. ” Rather, these articles should be interpreted to mean “at least one” or “one or more. ” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A computer-implemented method comprising:
transforming sensor data into a first spatial representation;
transforming a graphical user interface to display the first spatial representation;
transforming the sensor data into a second spatial representation;
providing the second spatial representation as input features to a machine learning model to generate inference data;
providing the input features, parameters of the machine learning model, and the inference data to an explainability model to generate explainability data;
transforming the explainability data into a third spatial representation, the third spatial representation being in a same space as the first spatial representation; and
transforming the graphical user interface to overlay the third spatial representation on the first spatial representation.

2. The method of claim 1, wherein:
the first spatial representation and the third spatial representation are in a display space for output to a display; and
the second spatial representation is in a feature space for input to the machine learning model.

3. The method of claim 1, wherein the explainability data indicates a first area of the second spatial representation that the machine learning model is focusing on.

4. The method of claim 3, wherein the third spatial representation indicates a second area of the first spatial representation that maps to the first area.

5. The method of claim 3, further comprising:
transforming the graphical user interface to allow a user to indicate whether the machine learning model is focusing on a correct area of the first spatial representation;
in response to the user indicating that the machine learning model is not focusing on the correct area of the first spatial representation, transforming the graphical user interface to allow the user to add a label indicating the correct area of the first spatial representation; and
retraining the machine learning model according to the label.

6. The method of claim 1, further comprising:
generating metrics based on the explainability data;
determining whether the metrics meet a condition; and
in response a determination of the metrics meeting the condition, adding the explainability data to a machine learning training data store;
wherein the explainability data includes an attribution map indicating portions of the input features that the machine learning model is focusing attention on.

7. The method of claim 6, wherein:
the metrics include a variance in locations of centroids of the attribution map; and
the condition is met when the variance exceeds a threshold value.

8. The method of claim 6, wherein:
the metrics include a change in a density of the attribution map; and
the condition is met when the change exceeds a threshold value.

9. The method of claim 6, wherein:
the metrics include a change in a number of centroids in the attribution map; and
the condition is met when the change exceeds a threshold value.

10. The method of claim 6, further comprising:
transforming the inference data into a fourth spatial representation; and
transforming the graphical user interface to overlay the fourth spatial representation on the first spatial representation;
wherein the metrics include a number of intersections between portions of the attribution map and the fourth spatial representation; and
the condition is met when the number of intersections is below a threshold value.

11. A system comprising:
non-transitory computer-readable storage media storing instructions; and
at least one electronic processor configured to execute the instructions to:
transform sensor data into a first spatial representation,
transform a graphical user interface to display the first spatial representation,
transform the sensor data into a second spatial representation,
provide the second spatial representation as input features to a machine learning model to generate inference data,
provide the input features, parameters of the machine learning model, and the inference data to an explainability model to generate explainability data,
transform the explainability data into a third spatial representation, the third spatial representation being in a same space as the first spatial representation, and
transform the graphical user interface to overlay the third spatial representation on the first spatial representation.

12. The system of claim 11, wherein:
the first spatial representation and the third spatial representation are in a display space for output to a display; and
the second spatial representation is in a feature space for input to the machine learning model.

13. The system of claim 11, wherein the explainability data indicates a first area of the second spatial representation that the machine learning model is focusing on.

14. The system of claim 13, wherein the third spatial representation indicates a second area of the first spatial representation that maps to the first area.

15. The system of claim 13, wherein the electronic processor is further configured to execute the instructions to:
transform the graphical user interface to allow a user to indicate whether the machine learning model is focusing on a correct area of the first spatial representation;
in response to the user indicating that the machine learning model is not focusing on the correct area of the first spatial representation, transform the graphical user interface to allow the user to add a label indicating the correct area of the first spatial representation; and
retrain the machine learning model according to the label.

16. The system of claim 11, wherein the at least one electronic processor is further configured to execute the instructions to:
generate metrics based on the explainability data;
determine whether the metrics meet a condition; and
in response a determination of the metrics meeting the condition, add the explainability data to a machine learning training data store;
wherein the explainability data includes an attribution map indicating portions of the input features that the machine learning model is focusing attention on.

17. The system of claim 16, wherein:
the metrics include a variance in locations of centroids of the attribution map; and
the condition is met when the variance exceeds a threshold value.

18. The system of claim 16, wherein:
the metrics include a change in a density of the attribution map; and
the condition is met when the change exceeds a threshold value.

19. The system of claim 16, wherein:
the metrics include a change in a number of centroids in the attribution map; and
the condition is met when the change exceeds a threshold value.

20. The system of claim 16, wherein the at least one electronic processor is further configured to execute the instructions to:
transform the inference data into a fourth spatial representation; and
transform the graphical user interface to overlay the fourth spatial representation on the first spatial representation;
wherein the metrics include a number of intersections between portions of the attribution map and the fourth spatial representation; and
the condition is met when the number of intersections is below a threshold value.
